(19) United States
(12) Patent Application Publication
(10) Pub. No.: US 2022/0105818 A1
(43) Pub. Date: Apr. 7, 2022

(54) TERMINAL ASSEMBLY FOR AN ELECTRIC VEHICLE CHARGER, CHARGER AND METHOD OF MANUFACTURING OF BOTH

(71) Applicant: Easee AS, Sandnes (NO)

(72) Inventors: Kjetil Næsje, Sandnes (NO); Jonas Helmikstøl, Hafrsfjord (NO); Steffen Mølgaard, Stavanger (NO); Ola Stengel, Stavanger (NO)

(73) Assignee: Easee AS, Sandnes (NO)

(21) Appl. No.: 17/428,879

(22) PCT Filed: Feb. 17, 2020
(86) PCT No.: PCT/NO2020/050039

§ 371 Date: Aug. 5, 2021

(30) Foreign Application Priority Data
Feb. 15, 2019 (NO) 20190213

(51) Int. Cl. B60L 53/16; H02J 7/00; H01R 12/70; H01R 12/75; H01R 13/652; H01R 43/20; H01R 43/02

(52) U.S. Cl. CPC B60L 53/16; H02J 7/0042; H02J 7/00304; H01R 12/7088; H01R 2201/26; H01R 13/652; H01R 43/205; H01R 43/02; H01R 12/75

(57) ABSTRACT

A terminal assembly for an electric vehicle charger, the charger having a connector socket configured for receiving an electric plug from a charging cable, the connector socket having a plurality of power output pins, wherein the terminal assembly has: the plurality of power output pins; a plurality of conductors for connecting the power output pins to a print-ed circuit board; and a support unit for receiving the conductors and for arranging and holding the conductors in a fixed position relative to each other, the terminal assembly being mountable directly onto the printed circuit board. An electric vehicle charger comprising the terminal assembly is also described as well as methods for manufacturing of the terminal assembly and of the electric vehicle charger.

### CROSS-REFERENCE TO RELATED APPLICATIONS

This application is the U.S. national stage application of International Application PCT/NO2020/050039, filed Feb. 17, 2020, which international application was published on Aug. 20, 2020, as International Publication WO 2020/167141 in the English language. The International Application claims priority of Norwegian Patent Application No. 20190213, filed Feb. 15, 2019. The international application and Norwegian application are both incorporated herein by reference, in entirety.

### FIELD OF THE INVENTION

The invention relates to a terminal assembly for an electric vehicle charger, a charger comprising the terminal assembly, and a method of manufacturing of the terminal assembly as well as of the charger.

### BACKGROUND OF THE INVENTION

The background of the invention is that prior art chargers for electric vehicles are generally expensive to produce, mainly because they are complex and time consuming to assemble, partly because manual labour must be involved. In the following, reference will often be made to a Type 2 charger. However, it must be understood that the invention disclosed herein is not limited to this specific type of charger.

The invention has for its object to remedy or to reduce at least one of the drawbacks of the prior art, or at least provide a useful alternative to prior art.

### SUMMARY OF THE INVENTION

The invention concerns a terminal assembly for an electric vehicle charger, wherein the terminal assembly may be assembled and tested before assembly of the complete charger. The invention also concerns a charger comprising said terminal assembly. The charger is made easy to assemble and with all contents inside one box, or housing, ready for mounting on for instance a wall in the garage of the user's home, where a power source is provided.

The object is achieved through features which are specified in the description below and in the claims that follow.

The invention is defined by the independent patent claims. The dependent claims define advantageous embodiments of the invention.

In a first aspect the invention relates more particularly to a terminal assembly for an electric vehicle charger, the electric vehicle charger comprising a connector socket, such as a type-2 connector socket, the connector socket being externally accessible and configured for receiving an electric plug from a charging cable, the electric vehicle charger comprising a printed circuit board, the connector socket having a plurality of power output pins, wherein the terminal assembly comprises:
the plurality of power output pins of the connector socket;
a plurality of conductors connected to the plurality of power output pins for connecting the power output pins to the printed circuit board (PCB); and
a support unit for receiving the conductors and for arranging and holding the conductors in a fixed position relative to each other, the terminal assembly being mountable directly onto the PCB.

The term “output pins” is the same as sometimes called output terminals. The output pins are the pins that deliver power to the electric vehicle when the vehicle is connected to the charger via the charger cable.

Each power output pin is connected to a conductor which in turn is connected to a printed circuit board. The conductors are arranged on a support unit which is mountable directly onto the PCB. This means that the support unit “holds” the conductors and power output pins so that the entire terminal assembly can be mounted onto the PCB in one piece. In prior art chargers the pins are usually connected to one flexible cable each and arranged in a small housing from which the cables exit. The use of cables requires manual work (by an electrician) both for connecting the pins to the cables and for coupling the cables to other parts of the charger.

The advantages of the invention according to the first aspect, are therefore both that the direct connection of the power output pins to the PCB eliminates manual work, it makes the charger more compact and with fewer movable parts. The fact that the conductors are mounted in connection with the support unit, has the advantage that all the power output pins are connected to the PCB at the same time, in one operation, and the advantage that the entire terminal assembly can be handled by a robot. No manual work is required for arranging the pre-assembled terminal assembly on the PCB.

Furthermore, screw connections are avoided. This again reduces the need for manual work, and also reduces the risk of loosening of the power output pins. Screw pins often loosen their original torque over time, especially when temperatures are varying a lot. This is often the case in chargers for electric vehicles which are mounted outdoors and are heating up every time an electric vehicle is connected to it for charging.

The connector socket may further be provided with at least one signalling pin and a fullcurrent protective earth pin, the terminal assembly comprising further conductors for connecting the signalling pin and the full-current protective earth pin to the PCB.

The conductors may be rigid. This has the additional effect that also the conductors may be easily handled by a robot. Rigid conductors also have the advantage that they may be bent into desired shapes and keep the shape. The end portion of rigid conductors which are connected to the PCB, will more easily hit the exact correct point immediately when mounted, i.e. it is easier to mount the support unit on the PCB when the conductors at least in that end portion are rigid.

Each of the conductors may comprise at least two portions arranged at an angle to each other. As mentioned above, rigid conductors may be bent into a desirable shape. Also, the conductors may comprise different portions, at least two, which are arranged at an angle to each other. This may be caused by the bending of one conductor, or by connecting separate conductor pieces to form a conductor with portions at an angle to each other.

The connector socket may, as mentioned above, be a type-2 connector socket.

The terminal assembly may further comprise a residual current device (RCD) arranged in connection with the support unit. The advantage of this is that also the RCD is eliminated as a separate part to be mounted on the PCB. The terminal assembly, including the RCD, may be tested before mounting into the charger. This way, any problems with the pins, conductors, or RCD may be detected before the charger is completely mounted. This is cost saving and work saving. Also, maintenance work is much easier when the entire terminal assembly may be changed for a new one.

The conductors from the power output pins may pass through the RCD. When the conductors of the power output pins, for a type 2 socket this goes for the pins L1, L2, L3 and N, pass through the RCD any leakage may be detected before mounting onto the PCB.

The support unit may be made of a transparent material for instance transparent plastics material. This is for easier inspection of the components housed in the support unit or which are placed between the support unit and the PCB or other components of the charger.

The terminal assembly may be provided with a click-on mechanism for removable connection to the PCB. The click-on mechanism may advantageously be arranged on the support unit. The click-on mechanism further simplifies the assembly of the charger which the terminal assembly forms part of.

The terminal assembly may further be provided with a plug locking motor for locking the charger to the charger cable from the electric vehicle when charging. The plug locking motor may be mounted on the support unit.

In a second aspect the invention relates more particularly to an electric vehicle charger for an electric vehicle, the electric vehicle charger comprising a terminal assembly according to the first aspect of the invention, the electric vehicle charger further comprising:
the connector socket, such as a type-2 connector socket, the connector socket being externally accessible and having a plurality of power output pins;
the printed circuit board (PCB); and
a housing enclosing the PCB and the terminal assembly arranged thereon.

One of the advantages of the electric vehicle charger as disclosed herein, is that the power output socket is the same physical unit which contains the electronics. This means that the housing enclosing the PCB and the terminal assembly arranged thereon is also provided with a power output socket for receiving the power output pins, disclosed above as the “connector socket”.

The PCB may further be provided with a power inlet, wherein the power inlet comprises power input pins for connection to a power source. Placing all the power components (current carrying components) onto the same PCB is an advantage because, in addition to reducing cost, complexity and electrical losses, it also simplifies manufacturing of the electric vehicle charger since there is now only one PCB to be tested and mounted.

The PCB may further be provided with relays. It is advantageous that the same PCB also holds the relays because connections between different PCBs can be avoided. Also, cable connectors can be avoided.

Overall, a charger wherein both the output terminal (power output pins), the input terminal (power input pins) and possibly also the relays are mounted onto the same PCB is advantageous because cable connections are avoided. This again causes less heat loss. And when heat loss is reduced, or almost eliminated, the need for a fan or other cooling means is also eliminated. This further simplifies the charger and saves cost, time and material when producing the charger. Avoiding the use of fans for cooling the charger significantly reduces the need for maintenance work and also increases the reliability of the charger.

Having all the power pins (input and output) connected to the same PCB provides for an easy way to measure individual temperature for all the power pins in order to ensure that a possible overheat condition is detected promptly.

In a third aspect the invention relates more particularly to a method of manufacturing of the terminal assembly according to the first aspect, the method comprising the following steps:
fastening each of the power output pins to a corresponding conductor; and
arranging the conductors on the support unit so that the conductors are arranged in fixed positions relative to each other.

The conductors may be rigid as described hereinabove.

Each of the rigid conductors may comprise at least two portions arranged at an angle to each other.

The power output pins may be connected to the conductors by means of soldering.

The method steps may be performed by a robot.

In a fourth aspect the invention relates more particularly to a method of manufacturing the electric vehicle charger according to the second aspect. The method may comprise the steps of arranging the terminal assembly onto the PCB and placing the PCB in the housing. The method steps may be performed by a robot.

### BRIEF DESCRIPTION OF THE DRAWINGS

In the following is described an example of a preferred embodiment illustrated in the accompanying drawings, wherein:

FIG. 1 shows a terminal assembly mounted onto a PCB;

FIG. 2 shows an inside of a charger housing having a socket for receiving the power outlet pins, and the terminal assembly;

FIGS. 3a-3b show a support unit;

FIG. 4 shows an RCD;

FIG. 5 shows the arrangement of conductors and RCD on a PCB but without the support unit;

FIGS. 6a-6d show mounting of the RCD and conductors on the PCB;

FIGS. 7a-7c show rigid conductors, rigid conductors connected to power output pins, current protective earth pin, and the terminal assembly mounted onto a PCB, respectively;

FIGS. 8a-8c show the type-2 pins placed directly onto the PCB;

FIGS. 9a-9i show one embodiment of a complete PCB assembly for being mounted into the charger housing, wherein the figure shows the same embodiment when seen from many different perspectives;

FIGS. 10a-10c show the inside of a front part of the charger housing, when being connected to the terminal assembly of the first aspect of the invention;

FIGS. 11a-11d show four cut-through views of the power output pins in the charger housing;

FIG. 12 shows four different ways of connecting the power output pins to the PCB, wherein situation C and D represent examples of conductors having at least two portions arranged at an angle to each other;

FIG. 13 shows examples of possible terminations of the conductor on the PCB;

FIG. 14 shows examples of possible fastening options between the connector, i.e. the power pins, and the conductor;

FIG. 15 shows further examples of possible fastening options between the power pins and the conductors;

FIG. 16 shows perspective views of the pins provided with their conductors;

FIG. 17 shows the pins of FIG. 16 yet seen from another perspective view;

FIG. 18 shows the holders for the two signal pins and how these components are connected;

FIG. 19 shows the locking motor of the terminal assembly;

FIG. 20a shows a first step of a method of assembling the terminal assembly of the invention;

FIG. 20b shows a second step of a method of assembling the terminal assembly of the invention;

FIG. 21a shows a third step of a method of assembling the terminal assembly of the invention;

FIG. 21b shows a fourth step of a method of assembling the terminal assembly of the invention;

FIG. 22a shows a fifth step of a method of assembling the terminal assembly of the invention;

FIG. 22b shows a sixth step of a method of assembling the terminal assembly of the invention;

FIG. 23a shows a seventh step of a method of assembling the terminal assembly of the invention;

FIG. 23b shows an eighth step of a method of assembling the terminal assembly of the invention;

FIG. 24a shows a first step of a method of mounting the terminal assembly on a printed circuit board;

FIG. 24b shows a second step of a method of mounting the terminal assembly on a printed circuit board;

FIG. 25a shows a third step of a method of mounting the terminal assembly on a printed circuit board, and

FIG. 25b shows a fourth step of a method of mounting the terminal assembly on a printed circuit board;

### DETAILED DESCRIPTION OF THE EMBODIMENTS

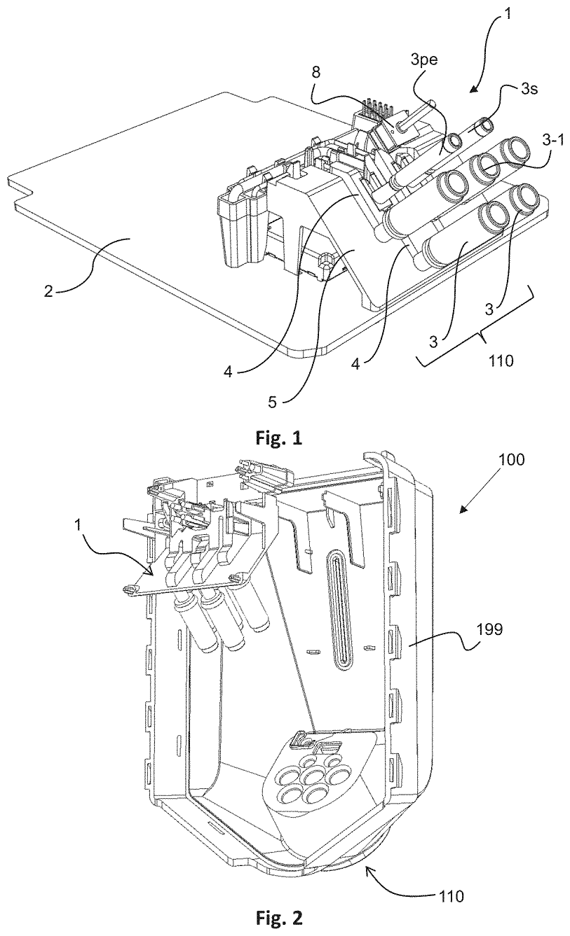

FIG. 1 shows a terminal assembly 1 mounted on a printed circuit board (PCB) 2. The figure shows a plurality of power output pins 3 each of which is connected to a conductor 4. The conductors are fixedly connected to a support unit 5. One of the power output pins 3-1 is a ground pin as illustrated. The power output pins 3 form part of a connector socket 110. The connector socket in this example complies with a type-2 cable plug, which is most used for electric vehicles. However, the invention is not limited to type-2 cable plugs.

The connector socket 110 for a type-2 cable also comprises further pins, namely a signalling pin 3s and a full-current protective earth pin ape as illustrated. These pins, which typically carry control signals, have functions which are well-known to the person skilled in the art. FIG. 1 further shows a plug locking motor 8, which is also known as such in the field of electric vehicle chargers. However, in the current terminal assembly 1 in accordance with the invention it may be conveniently integrated as illustrated. The plug locking motor 8 will be further discussed in view of other figures.

FIG. 2 shows an inside of a charger housing 199 having a connector socket 110 for receiving the power outlet pins, and the terminal assembly 1.

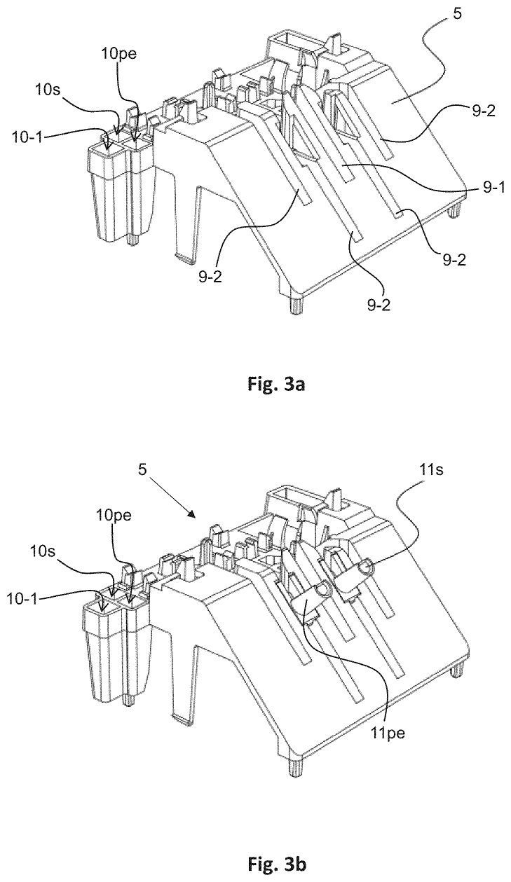

FIGS. 3a-3b show a support unit 5. The figure serves to illustrate how the support unit 5 is configured and shaped for receiving, arranging and holding the conductors 3, 3-1 in accordance with the invention. In order to achieve this, the support unit 5 comprises recesses 9-2 for receiving the conductors 4 for connecting the power output pins 3 and a recess 9-1 for receiving the conductor 4-1 for connecting the ground pin 3-1 as illustrated in FIG. 3a. Furthermore, the support unit 5 comprises a first receiving channel 10-1 for receiving part of the ground pin conductor, a second receiving channel 10s for receiving part of the signalling pin conductor, and a third receiving channel 10pe for receiving part of the protective earth pin conductor, all channels being arranged in a corner of the support unit 5 as illustrated.

FIG. 3b shows the support unit 5 when being provided with two pin holders, one signalling pin holder 11s and one protecting earth pin holder 11pe, as illustrated.

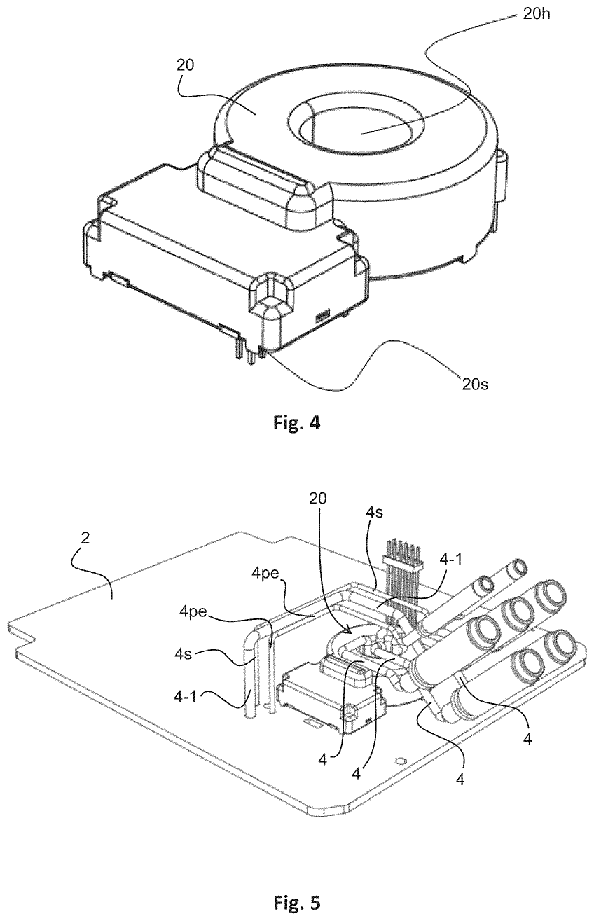

FIG. 4 shows an RCD 20. FIG. 5 shows the arrangement of conductors and RCD on a PCB but without the support unit. Such residual current device 20 typically comprises a conductor receiving hole 20h as illustrated, through which a conductor is to be led, so that the current through the conductor can be measured by the device. Furthermore, the RCD 20 comprises a signal pin 20s at its underside for convenient connecting with (being soldered to) the printed circuit board 2. Residual current devices, as such, are well-known to the person skilled in the art. However, the inventors came up with an advantageous solution to combine the RCD with the terminal device 1 in accordance with the invention. This is achieved by making all conductors 4 of the phase output power pins run through the opening of the RCD 20 that is mounted directly on the printed circuit board 2 as illustrated in FIG. 5. The conductor 4-1 for the ground pin, the conductor 4s for the signalling pin and the conductor 4pe for the protective earth pin 4pe are not led through the opening 20h. In this way the RCD 20 may measure accurately any residual current running through the phase output power pins 3.

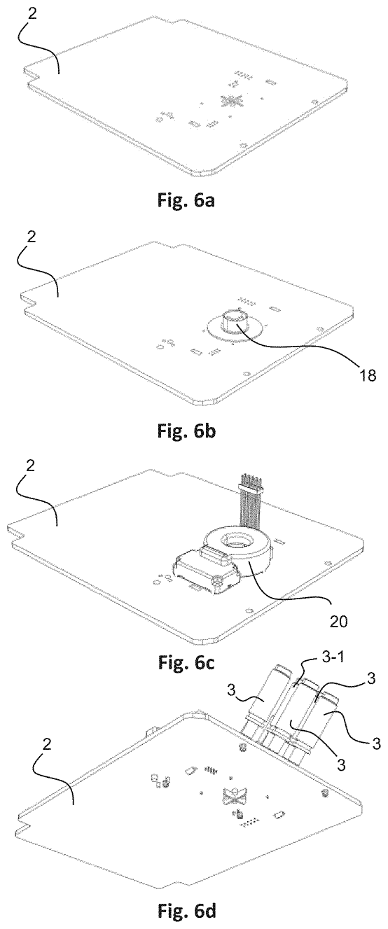

FIGS. 6a-6d show mounting of the RCD 20 and conductors on the PCB 2. These figures illustrate how the RCD 20 is preferably mounted on the PCB 2. In FIG. 6a the PCB 2 is provided having conductor tracks and the like provided thereon. Then, in FIG. 6b, at the location where the conductors of the terminal assembly 1 are to be connected to the PCB, first an isolation tube 18 is provided as illustrated. The isolation tube 18 is formed such that it fits in a predefined cross-shaped hole in the PCB 2, as illustrated. Then, in FIG. 6c the RCD 2 is placed with its hole around the isolation tube 18. The reason for providing the isolation tube is to make the product comply with the safety standards that are set in the market. The isolation tube 18 is formed such that it fits in a predefined cross-shaped hole in the PCB 2, as illustrated in FIG. 6d. The isolation tube 18 sticks a bit out of the surface of the PCB 2. Also in FIG. 6d the terminal assembly has been provided with its power and ground pins 3, 3-1 visible.

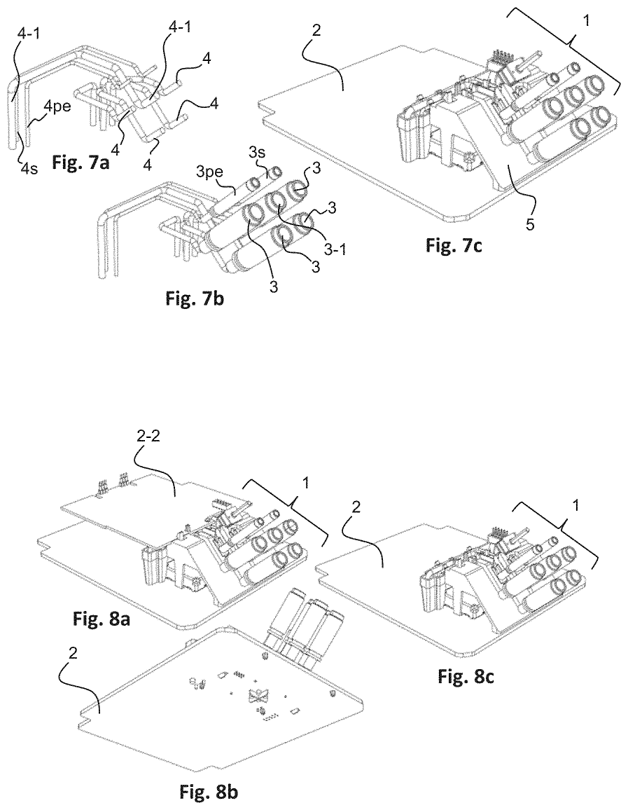

FIGS. 7a-7c show rigid conductors, rigid conductors connected to power output pins, current protective earth pin, and the terminal assembly mounted onto a PCB, respectively. FIG. 7a shows only the conductors, including the conductors 4 for connecting the power output pin, the conductor 4-1 for connecting the ground pin, the conductor 4s for connecting the signalling pin, and the conductor 4pe for connecting the protective earth pin 4pe. FIG. 7b shows the conductors when mounted to their respective pins 3, 3-1, 3s, 3pe. FIG. 7c shows the terminal assembly 1 when being mounted on the PCB 2. The great advantage of the invention is that the terminal assembly 1 can be mounted on the PCB 2 as a unit, which makes the assembly much easier and also allows for a robot to carry out the process.

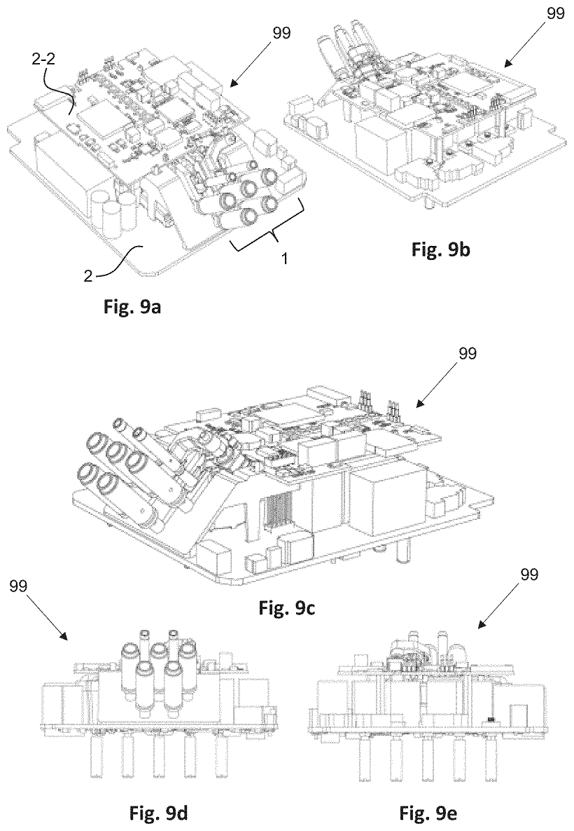

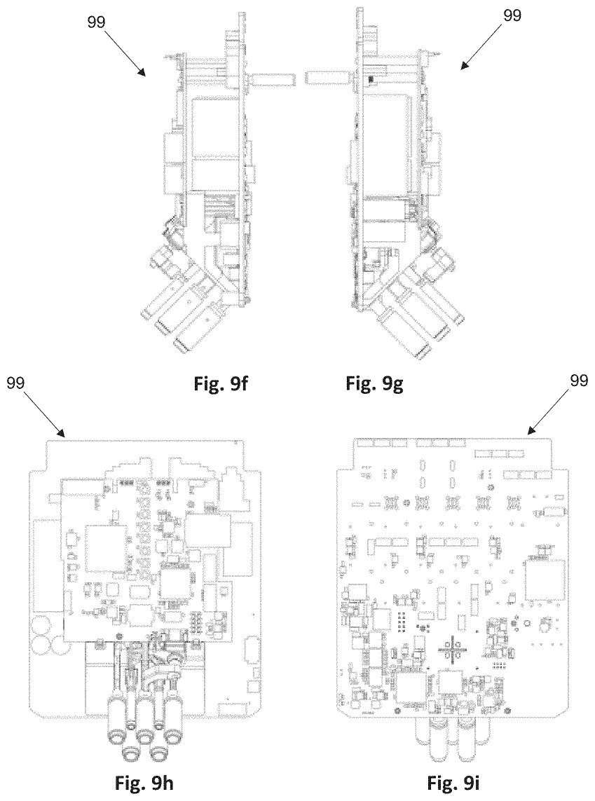

FIGS. 8a-8c show the type-2 pins placed directly onto the PCB. These figures show that the configuration of the invention allows for the provision of a further PCB 2-2, which may conveniently embody further components of a PCB assembly of the electric vehicle charger. This allows for a very compact solution. FIG. 9 shows one embodiment of such complete PCB assembly 99 for being mounted into the charger housing 199, wherein the figure shows the same embodiment when seen from many different perspectives.

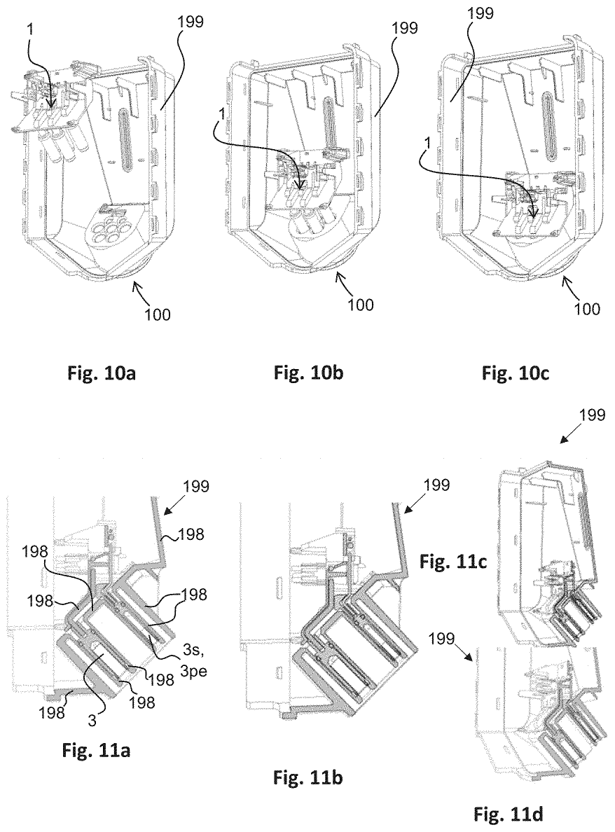

FIGS. 10a-10c show the inside of a front part of the charger housing 110, when being connected to the terminal assembly 1 of the first aspect of the invention. These figures clearly illustrate how the terminal assembly 1 is conveniently inserted from the backside into the hole of the connector socket 110.

FIG. 11 shows four cut-through views of the power output pins in the charger housing 199. The figure serves to illustrate how the pins 3, 3s, 3pe are surrounded by plastic material 198 of the charger housing 199.

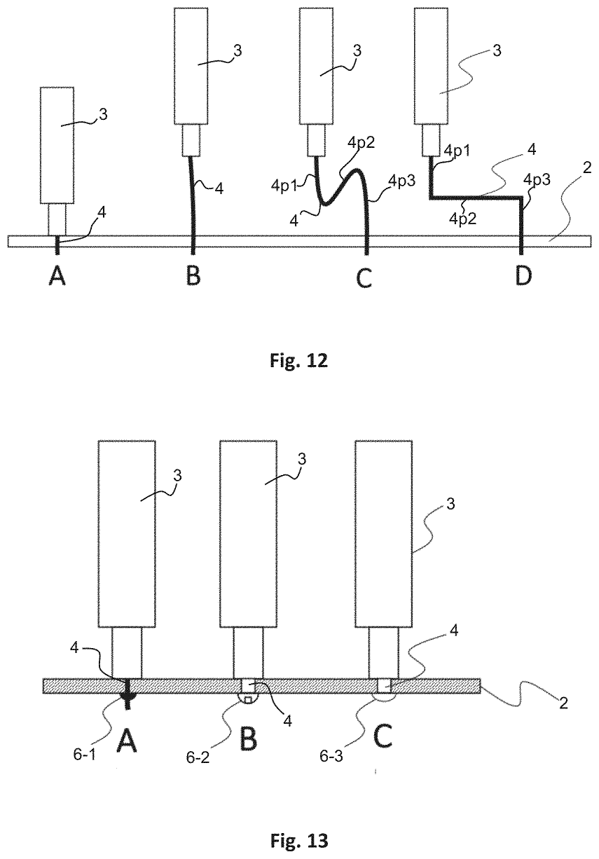

FIG. 12 shows four different ways of connecting the power output pins 3 to the PCB 2, wherein C and D represent examples of conductors having at least two portions 4p1, 4p2, 4p3 arranged at an angle to each other. Configurations C and D clearly reduce the stress (pressure and deformation forces) applied by the type-2 plug to the PCB 2.

FIG. 13 shows examples of possible terminations of the conductor on the PCB 2. Configuration A shows a soldered termination 6-1. Configuration B shows a screw termination 62. Configuration C shows a riveted termination 6-3.

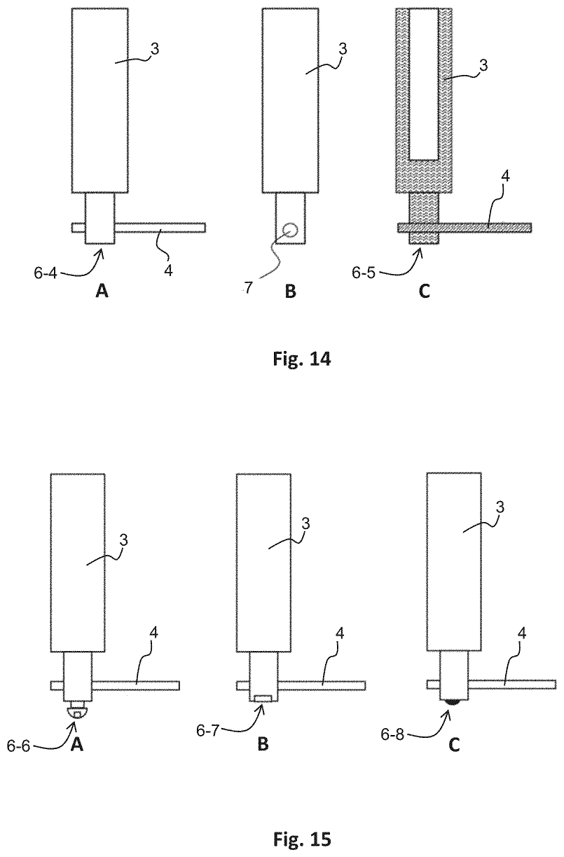

FIG. 14 shows examples of possible fastening options between the connector, i.e. the power pins 3, and the conductor 4. Configuration A represents one of a riveted, soldered, press-fitted or screw termination. Configuration B shows a hole 7 at the end of the pin 3. Configuration C shows a cross-section of a side-termination 6-5 of a female connector 3.

FIG. 15 shows further examples of possible fastening options between the power pins and the conductors. Configuration A shows a screw side termination. Configuration B shows a riveted side termination. Configuration C shows a soldered side termination.

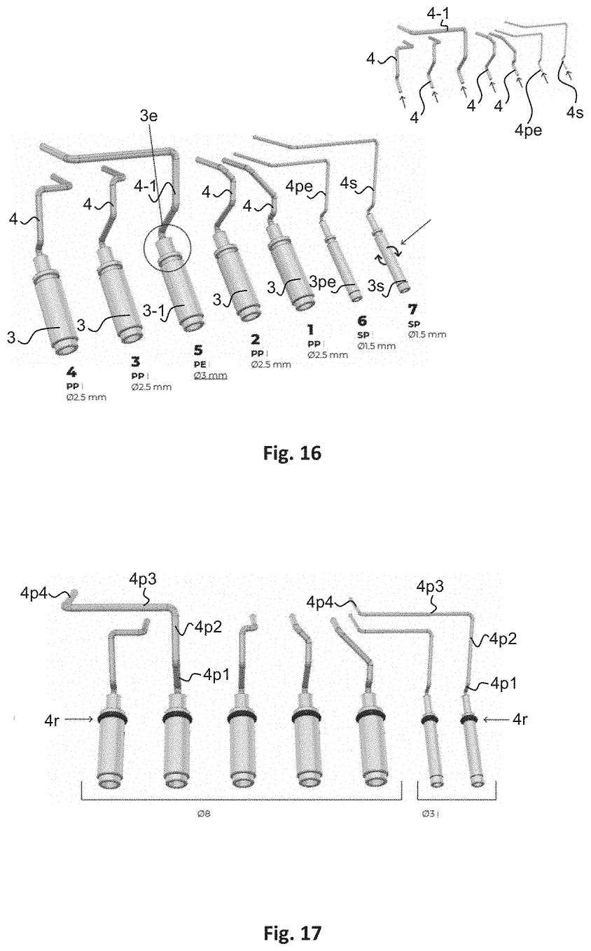

FIG. 16 shows perspective views of the pins 3, 3-1, 3s, 3pe provided with their conductors 4, 4-1, 4s, 4pe. It can be observed that the ground pin 3-1 has an end portion 3e which is thicker than the other pins. This makes it easier to distinguish between the pins and reduces the chance of wrong assembly. FIG. 17 shows the pins of FIG. 16 seen from another perspective view. The pins are rotation symmetric as indicated by the arrows. What is clearly visible from these figures is that the conductors 4 are pre-shaped with various parts 4p1, 4p2, 4p3, 4p4, which are under respective angles with each other. On the one hand this is for actually routing the conductor along the right path along the earlier discussed recesses 9-1, 9-2 and channels 10-1, 10s, 10pe in the support unit 5 to the right position on the printed circuit board 2, but it also serves to reduce stresses applied by the type-2 plug to the PCB when inserted into the connector socket 110. FIG. 17 shows also O-rings 4r around the pins 3, 3-1, 3s, 3pe, which ensure proper fitting, but also prevent water from entering the housing.

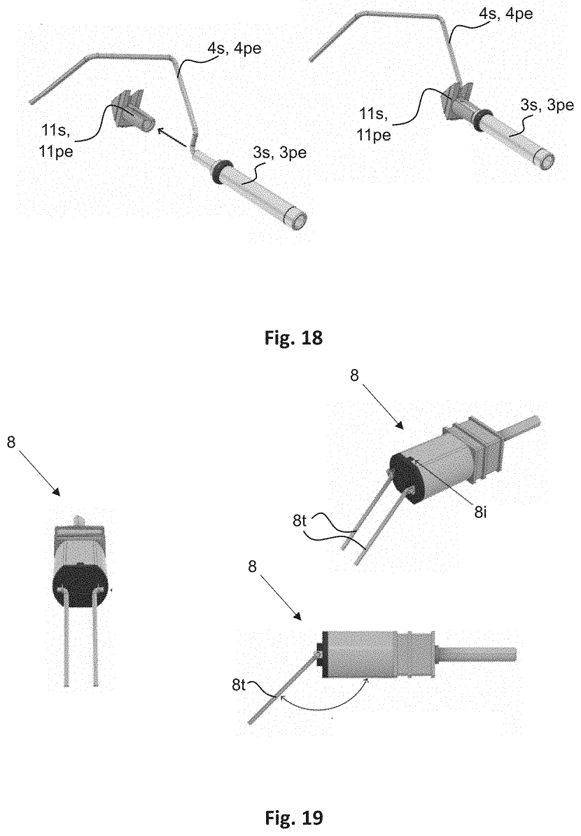

FIG. 18 shows the holders 11s, 11pe for the two signal pins 3s, 3pe and how these components are connected.

FIG. 19 shows the locking motor 8 of the terminal assembly 1. The locking motor 8 has terminals 8t, which are under an angle with the locking motor 8 for facilitating mounting of the locking motor on the terminal assembly 1. The locking motor 8 is also provided with an indicator, which must be visible on the top when mounting the locking motor 8.

The following figures illustrate the significant advantage of the terminal assembly 1 of the invention as discussed until now. This advantage is that the terminal assembly is very easy to assemble, and may also conveniently be automated using an automated robot.

The major idea is that a single unit, the terminal assembly 1, is made first as illustrated by the following figures, where after the terminal assembly 1 as a unit is placed on and connected with the printed circuit board 2.

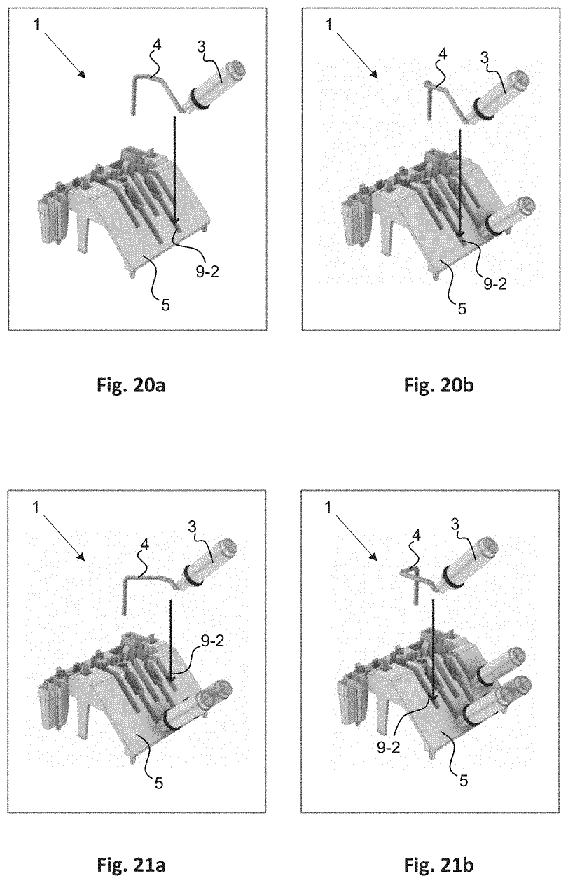

FIG. 20a shows a first step of a method of assembling the terminal assembly 1 of the invention. In this step a first power output pin 3 with its connecting conductor 4 is placed in the respective recess 9-2 of the support unit 5 as illustrated. This power output pin 3 typically carries one of the phase signals or neutral. The free end of the conductor 4 is led to the location where the conductor receiving hole of the RCD 20 will be located.

FIG. 20b shows a second step of a method of assembling the terminal assembly 1 of the invention. In this step a second power output pin 3 with its connecting conductor 4 is placed in the respective recess 9-2 of the support unit 5 as illustrated. This power output pin 3 typically carries one of the phase signals or neutral. The free end of the conductor 4 is led to the location where the conductor receiving hole of the RCD 20 will be located.

FIG. 21a shows a third step of a method of assembling the terminal assembly 1 of the invention. In this step a third power output pin 3 with its connecting conductor 4 is placed in the respective recess 9-2 of the support unit 5 as illustrated. This power output pin 3 typically carries one of the phase signals or neutral. The free end of the conductor 4 is led to the location where the conductor receiving hole of the RCD 20 will be located.

FIG. 21b shows a fourth step of a method of assembling the terminal assembly 1 of the invention. In this step a fourth power output pin 3 with its connecting conductor 4 is placed in the respective recess 9-2 of the support unit 5 as illustrated. This power output pin 3 typically carries one of the phase signals or neutral. The free end of the conductor 4 is led to the location where the conductor receiving hole of the RCD 20 will be located. This step completes the mounting of the conductors 4 on the support unit 5 that will run through the RCD 20. The other conductors will be led to other positions on the support unit 5 as will be explained hereinafter.

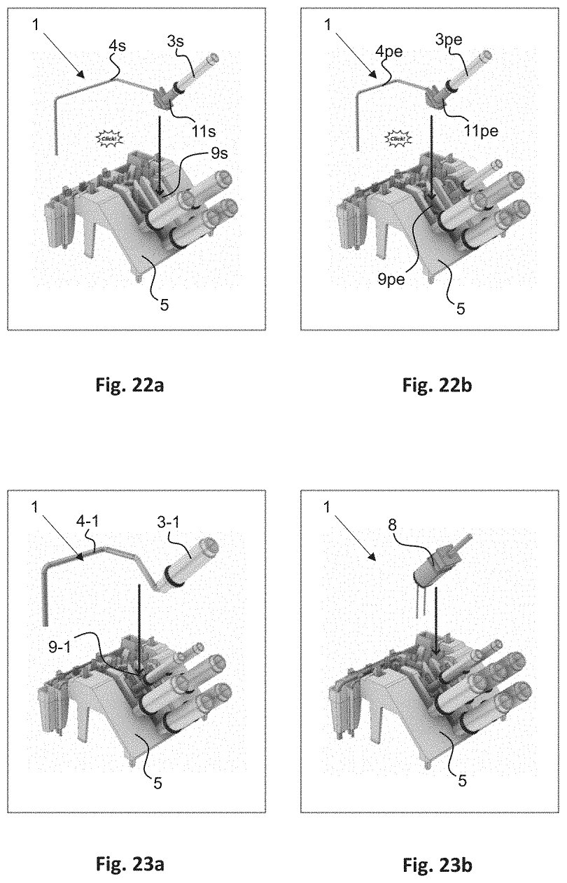

FIG. 22a shows a fifth step of a method of assembling the terminal assembly 1 of the invention. In this step a signalling pin 3s together with its connecting conductor 4s and its signalling pin holder 11s is placed in a respective recess 9s of the support unit 5 as illustrated. The configuration is designed such that a click is heard when the pin assembly 3s, 4s, 11s is placed in the recess 9s. The free end of the conductor 4s is led into the receiving channel 10s at the corner of the support unit 5 as illustrated.

FIG. 22b shows a sixth step of a method of assembling the terminal assembly 1 of the invention. In this step a protective earth pin 3pe together with its connecting conductor 4pe and its signalling pin holder 11pe is placed in a respective recess 9pe of the support unit 5 as illustrated. The configuration is designed such that a click is heard when the pin assembly 3pe, 4pe, 11pe is placed in the recess 9pe. The free end of the conductor 4pe is led into the receiving channel 10pe at the corner of the support unit 5 as illustrated.

FIG. 23a shows a seventh step of a method of assembling the terminal assembly 1 of the invention. In this step a ground pin 3-1 with its connecting conductor 4-1 is placed in the respective recess 9-1 of the support unit 5 as illustrated. This ground pin 3-1 defines the ground potential of the charger. The free end of the conductor 4-1 is led into the receiving channel 10-1 at the corner of the support unit 5 as illustrated.

FIG. 23b shows an eighth step of a method of assembling the terminal assembly 1 of the invention. In this step the earlier-discussed plug locking motor 8 is mounted on the support unit 5. The support unit 5 is specially designed and shaped to receive this motor 8 as illustrated.

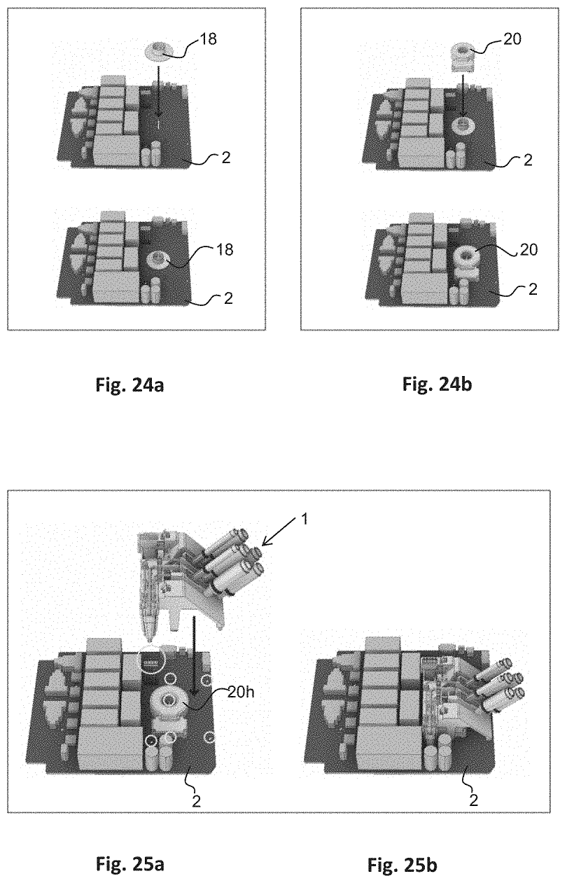

FIG. 24a shows a first step of a method of mounting the terminal assembly 1 on a printed circuit board 2. FIG. 24b shows a second step of a method of mounting the terminal assembly 1 on a printed circuit board 2. These figures serve to illustrate in more detail the relation and relative orientation between the insulation tube 18 and the RCD 20 (residual current device. In FIG. 24a the insulation tube 18 is mounted on the PCB 2 and in FIG. 24b the RCD 20 is placed with its hole around the insulation tube 18. This is done before soldering the RCD 20 to the PCB 2.

FIG. 25a shows a third step of a method of mounting the terminal assembly 1 on a printed circuit board 2. In this step the terminal assembly as assembled in FIG. 23b is placed on the RCD 20, wherein the respective ends of the conductors 4 are inserted in the receiving hole of the RCD 20.

FIG. 25b shows a fourth step of a method of mounting the terminal assembly 1 on a printed circuit board 2. Here the terminal assembly 1 has been soldered to the PCB 2. The assembly is now ready for further assembly, such as the mounting of the further PCB 2-2 as earlier discussed.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A terminal assembly for an electric vehicle charger, the electric vehicle charger comprising a connector socket, the connector socket being externally accessible and configured for receiving an electric plug from a charging cable, the electric vehicle charger comprising a printed circuit board, the connector socket having a plurality of power output pins, wherein the terminal assembly comprises:
the plurality of power output pins of the connector socket;
a plurality of conductors connected to the plurality of power out-put pins for connecting the power output pins to the printed circuit board; and
a support unit for receiving the conductors and for arranging and holding the conductors in a fixed position relative to each other,
the terminal assembly being mountable directly onto the printed circuit board.

2. The terminal assembly according to claim 1, wherein the connector socket is further provided with at least one signaling pin and a full-current protective earth pin, the terminal assembly comprising further conductors for connecting the signaling pin and the full-current protective earth pin to the printed circuit board.

3. The terminal assembly according to claim 1, wherein the conductors are rigid.

4. The terminal assembly according to claim 1, wherein each of the conductors comprises at least two portions arranged at an angle to each other.

5. The terminal assembly according to claim 1, wherein the connector socket is a type-2 connector socket.

6. The terminal assembly according to claim 1, the terminal assembly further comprising a residual current device arranged in connection with the support unit.

7. The terminal assembly according to claim 6, wherein the conductors from the power output pins pass through the residual current device.

8. The terminal assembly according to claim 1, wherein the support unit is made of a transparent material.

9. The terminal assembly according to claim 1, the terminal assembly being provided with a click-on mechanism for removable connection to the printed circuit board.

10. An electric vehicle charger, the electric vehicle charger comprising a terminal assembly, wherein the terminal assembly comprises:
the plurality of power output pins of the connector socket;
a plurality of conductors connected to the plurality of power out-put pins for connecting the power output pins to the printed circuit board; and
a support unit for receiving the conductors and for arranging and holding the conductors in a fixed position relative to each other, the terminal assembly being mountable directly onto the printed circuit board;
wherein the electric vehicle charger further comprises:
the connector socket, the connector socket being externally accessible and having a plurality of power output pins;
the printed circuit board; and
a housing enclosing the printed circuit board and the terminal assembly arranged thereon.

11. The electric vehicle charger according to claim 10, wherein the printed circuit board is further provided with a power inlet, wherein the power inlet comprises power input pins for connection to a power source.

12. The electric vehicle charger according to claim 10, wherein the printed circuit board is further provided with relays.

13. A method of manufacturing of the terminal assembly, wherein the terminal assembly comprises:
the plurality of power output pins of the connector socket;
a plurality of conductors connected to the plurality of power out-put pins for connecting the power output pins to the printed circuit board; and
a support unit for receiving the conductors and for arranging and holding the conductors in a fixed position relative to each other, the terminal assembly being mountable directly onto the printed circuit board;
wherein the method comprises the following steps:
fastening each of the power output pins to a corresponding conductor; and
arranging the conductors on the support unit so that the conductors are arranged in fixed positions relative to each other.

14. The method according to claim 13, wherein the conductors are rigid.

15. The method according to claim 14, wherein each rigid conductor comprises at least two portions arranged at an angle to each other.

16. The method according to claim 13, wherein the power output pins are connected to the conductors via soldering.

17. The method according to claim 13, wherein the method steps are performed by a robot.

18. A method of manufacturing the electric vehicle charger, the electric vehicle charger comprising a terminal assembly, wherein the terminal assembly comprises:
the plurality of power output pins of the connector socket;
a plurality of conductors connected to the plurality of power out-put pins for connecting the power output pins to the printed circuit board; and
a support unit for receiving the conductors and for arranging and holding the conductors in a fixed position relative to each other, the terminal assembly being mountable directly onto the printed circuit board;
wherein the electric vehicle charger further comprising:
the connector socket, the connector socket being externally accessible and having a plurality of power output pins;
the printed circuit board; and
a housing enclosing the printed circuit board and the terminal assembly arranged thereon;
wherein the method comprises the steps of arranging the terminal assembly onto the printed circuit board and placing the printed circuit board in the housing.

19. The method according to claim 18, wherein the method steps are performed by a robot.
